(19) United States
(12) Patent Application Publication
(10) Pub. No.: US 2014/0267322 A1
(43) Pub. Date: Sep. 18, 2014

(54) DISPLAY SIGNAL BUFFER

(71) Applicant: FRESCO LOGIC, INC., Beaverton, OR (US)

(72) Inventors: Robert G. McVay, Portland, OR (US); Christopher M. Meyers, Beaverton, OR (US); Jie Ni, Portland, OR (US)

(21) Appl. No.: 13/844,603

(22) Filed: Mar. 15, 2013

(51) Int. Cl. G06T 1/60

(52) U.S. Cl. CPC G06T 1/60
USPC 345/520

(57) ABSTRACT

Briefly, embodiments of methods or systems for a display signal buffer are disclosed.

### BACKGROUND

1. Field

This disclosure relates to a display signal buffer and, more particularly, to a display signal buffer smaller than a display frame.

2. Information

Conventionally, a buffer the size of a display frame is employed in connection with a display, such as one that may be used with a computer or similar device, such as a consumer electronics product. For example, where an additional (e.g., second) display is connected to a computer, a cable or similar hardware providing a communication path for display signals may be used to connect a device that includes a buffer the size of a display frame. However, manufacturing an integrated circuit with a buffer of this size may result in additional cost, such as in terms of materials and/or technology.

### BRIEF DESCRIPTION OF DRAWINGS

Claimed subject matter is particularly pointed out and/or distinctly claimed in the concluding portion of the specification. However, both as to organization and/or method of operation, together with objects, features, and/or advantages thereof, claimed subject matter may be understood by reference to the following detailed description if read with the accompanying drawings in which:

FIG. 1 is a schematic diagram of a prior art host computer and display system;

FIG. 2 is a schematic diagram of a host computer and display system embodiment;

FIG. 3 is a schematic diagram of an embodiment of a USB to VGA adapter;

FIG. 4 is a schematic diagram of an embodiment of a BIA adjustment mechanism to synchronize isochronous display rate;

FIG. 5 is a schematic diagram illustrating an embodiment of transmission of display signals in accordance with an isochronous mode embodiment;

FIG. 6 is a schematic diagram of an embodiment of a USB endpoint feedback mechanism to synchronize isochronous display rate;

FIG. 7 is a plot illustrating delay to stabilize the embodiment feedback mechanism as shown in FIG. 6;

FIG. 8 is a plot showing modulation in display buffer utilization during stabilization of the embodiment feedback mechanism as shown in FIG. 6;

FIG. 9 is a schematic diagram illustrating operation of an embodiment of a feedback mechanism to synchronize isochronous display rate; and

FIG. 10 is a schematic diagram illustrating an embodiment of a computing environment in which an embodiment of a display signal buffer may be employed.

Reference is made in the following detailed description to accompanying drawings, which form a part hereof, wherein like numerals may designate like parts throughout to indicate corresponding and/or analogous components. It will be appreciated that components illustrated in the figures have not necessarily been drawn to scale, such as for simplicity and/or clarity of illustration. For example, dimensions of some components may be exaggerated relative to other components. Further, it is to be understood that other embodiments may be utilized. Furthermore, structural and/or other changes may be made without departing from claimed subject matter. It should also be noted that directions and/or references, for example, up, down, top, bottom, and so on, may be used to facilitate discussion of drawings and/or are not intended to restrict application of claimed subject matter. Therefore, the following detailed description is not to be taken to limit claimed subject matter and/or equivalents.

### DETAILED DESCRIPTION

In the following detailed description, numerous specific details are set forth to provide a thorough understanding of claimed subject matter. For purposes of explanation, specific numbers, systems and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes and/or equivalents may occur to those skilled in the art. It is, therefore, to be understood that appended claims are intended to cover any and all modifications and/or changes as fall within claimed subject matter.

Reference throughout this specification to one implementation, an implementation, one embodiment, an embodiment and/or the like may mean that a particular feature, structure, or characteristic described in connection with a particular implementation or embodiment may be included in at least one implementation or embodiment of claimed subject matter. Thus, appearances of such phrases, for example, in various places throughout this specification are not necessarily intended to refer to the same implementation or to any one particular implementation described. Furthermore, it is to be understood that particular features, structures, or characteristics described may be combined in various ways in one or more implementations. In general, of course, these and other issues may vary with context. Therefore, particular context of description or usage may provide helpful guidance regarding inferences to be drawn.

Operations and/or processing, such as in association with networks, such as computer and/or communication networks, for example, may involve physical manipulations of physical quantities. Typically, although not necessarily, these quantities may take the form of electrical and/or magnetic signals capable of, for example, being stored, transferred, combined, processed, compared and/or otherwise manipulated. It has proven convenient, at times, principally for reasons of common usage, to refer to these signals as bits, data, values, elements, symbols, characters, terms, numbers, numerals and/or the like. It should be understood, however, that all of these or similar terms are to be associated with appropriate physical quantities and are intended to merely be convenient labels.

Likewise, in this context, the terms “coupled”, “connected,” and/or similar terms, may be used. It should be understood that these terms are not intended as synonyms. Rather, “connected” may be used to indicate that two or more elements or other components, for example, are in direct physical and/or electrical contact; while, “coupled” may mean that two or more components are in direct physical or electrical contact; however, “coupled” may also mean that two or more components are not in direct contact, but may nonetheless co-operate or interact. The term coupled may also be understood to mean indirectly connected, for example, in an appropriate context.

The terms, “and”, “or”, “and/or” and/or similar terms, as used herein, may include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms may be used to describe any feature, structure, and/or characteristic in the singular and/or may be used to describe a plurality or some other combination of features, structures and/or characteristics. Though, it should be noted that this is merely an illustrative example and claimed subject matter is not limited to this example. Again, particular context of description or usage may provide helpful guidance regarding inferences to be drawn.

It should be understood that for ease of description a computer may be embodied and/or described in terms of a computing device. However, it should further be understood that this description should in no way be construed that claimed subject matter is limited to one embodiment and instead, may be embodied as a variety of devices or combinations thereof, including, for example, one or more illustrative examples, as described later. In this context, the term computing device refers to any device capable of performing computations; such as, a desktop computer, a laptop computer, a tablet, a set top box, etc.; however, typically, a computing device may also be capable of sending and/or receiving signals (e.g., signal packets), such as via a wired or wireless network, may be capable of performing arithmetic and/or logic operations, processing and/or storing signals, such as in memory as physical memory states, and/or may, for example, operate as a client and/or as a server. The Internet refers to a decentralized global network of interoperable networks, including devices that are part of those interoperable networks. The Internet includes local area networks (LANs), wide area networks (WANs), wireless networks, and/or long haul public networks that, for example, may allow signal packets to be communicated between LANs. Signal packets, also referred to as signal packet transmissions, may be communicated between nodes of a network, including a computer network, where a node may comprise one or more devices, such as computing devices, for example.

A protocol refers to a set of signaling conventions for communications between or among devices, such as in a network, typically computing devices, as previously discussed; for example, devices that substantially comply with a protocol and/or that are substantially compatible with a protocol. In this context, the term “between” and/or similar terms are understood to include “among” if appropriate for the particular usage. Likewise, in this context, the terms “compatible with”, “comply with” and/or similar terms are understood to include substantial compliance or substantial compatibility. At times, a protocol may have several layers. These layers may be referred to here as a communication stack. Various types of communications may occur across various layers. For example, as one moves higher in a communication stack, additional functions may be available by transmitting communications that are compatible and/or compliant with a particular protocol at these higher layers.

As previously mentioned, conventionally, a buffer the size of a display frame may be employed in connection with a display, such as one that may be used with a computer or similar device, such as a consumer electronics product. For example, where an additional (e.g., second) display may be connected to a computer or a consumer electronics product, a cable or similar hardware providing a communication path for display signals may be used to connect a device that includes a buffer the size of a display frame. However, manufacturing an integrated circuit with a buffer of this size may result in additional cost, such as in terms of materials and/or technology.

Typically, a display device, referred to herein generically as a display, such as a monitor, may be connected to a computer or a consumer electronics product utilizing a high speed digital connection, such as a serial connection, to form a computer network, for example. It is noted that there are several different bus protocols, including serial bus protocols, available and in use to provide a high speed digital connection. Claimed subject matter is intended to include any currently known high speed bus protocols or to be developed high speed bus protocols, including USB, 1394, Ethernet, WiGig, Thunderbolt, MHL and/or related or similar protocols, for example. A Universal Serial Bus (USB) compatible or compliant link, as an example, may be employed. It is noted that several versions of USB exist. In this context, the term USB is intended to refer to any known or to be developed versions of USB. More information regarding USB, including the current specification, is available from www.USB.org, for example. One currently available version of USB is referred to here as SuperSpeed USB, but may be known more generally as USB3, and is discussed in connection with an embodiment for illustration purposes. Likewise, typically, a display may be compatible or compliant with a computer graphics and/or video graphics protocol. Claimed subject matter is intended to include any current known or to be developed computer graphics and/or video graphics specifications, including VGA, DVI, HDMI, DisplayPort. and/or related or similar protocols, for example. It is noted that several versions of these specifications, including various derivatives thereof, exist. In this context, the term VGA is intended to refer to any known or to be developed video graphics standard. More information regarding VGA, DVI, HDMI, and DisplayPort including the current specifications, are available from www.VESA.org, www.HDMI.org, www.DDWG.org, and www.VESA.org, respectively.

Although claimed subject matter is not limited in scope to illustrative embodiments, for purposes of discussion, an embodiment employing a SuperSpeed USB link as a display connection and a computer as a host device driving a display to form a network, shall be presented to illustrate various features in accordance with claimed subject matter. As alluded to previously, an advantage, such as reduction in system cost, may be present compared with a conventional approach that includes a local frame buffer as part of a VGA device, for example. However, it is noted that claimed subject matter is not limited in scope to a particular advantage since it may depend on a particular embodiment.

FIG. 1, for example, illustrates a host computer (PC) 110, a USB to VGA adapter 120, which includes a USB connector 122, and a display 130. As illustrated by FIG. 1 and is conventional, USB to VGA adapter 120 includes a frame buffer, 125. FIG. 2 also illustrates a host computer (PC), shown as 210, a USB to VGA adapter, shown as 220, with a USB connector 222, and a display shown as 230. However, while adapter 220 includes a display signal buffer 225, as shown, and referred to as a line buffer, buffer 225 is smaller in size than frame buffer 125 of FIG. 1. Of course, claimed subject matter is not limited to a line buffer. For example, smaller buffers may be employed and potentially provide adequate performance in accordance with claimed subject matter. For the embodiment of FIG. 2, a frame buffer, 215, is included within general purpose system memory of computer 210, as explained in more detail below.

Computer 210 may include software able to obtain display signals, such as video, for example, generated, for example, by a platform comprising hardware, firmware and software interoperating to produce the display signals, and make the produced display signals available externally, such as via a USB port of the computer, to which USB connector 222 may be electrically and physically connected in this embodiment. Of course, claimed subject matter is not limited to USB, as previously indicated.

Display stack software may be capable of obtaining full display frames and/or display frame updates (e.g., partial display frames) in a manner so as to provide them to a VGA device driver, such as one able to drive a display. Likewise, a VGA device driver may be able to perform processing of display signals in a manner to support a line buffer or other buffer less than a frame buffer in size, such as 225, without significant degradation of display signals being transmitted to display 230, as explained in more detail below.

In operation, an embodiment in accordance with claimed subject matter of dynamic management of transmission of display signals may include at least two modes; full frame mode and/or a partial update mode. Full frame mode may operate in a manner so that if a call is made to a VGA device driver, for example, a full frame of display signals may be presented via a port of a computer, such as USB port 215, for display by 230. Thus, even if a small change has occurred since a most recently provided frame, e.g., a mouse moving, as a non-limiting example, a full frame may be transmitted via a port, in this example, to buffers of a display, such as VGA buffers, again, for this embodiment.

A second mode of operation may comprise partial update mode. In partial update mode, incremental changes to convert a full frame from a most recently transmitted frame to a current frame may be provided. Thus, using the previous example of mouse movement, a small rectangle that encapsulates a cursor change in position may be transmitted in an embodiment. Of course, as the amount of incremental change between two frames increases, partial update mode becomes more like or closer to full frame mode for an embodiment employing both modes.

It is, of course, understood that claimed subject matter is not limited in scope to a computer having one frame buffer. For example, multiple frame buffers may be allocated in memory. These frame buffers may be kept up to date, such as by writing a full frame update or a partial writing (e.g., editing) with a partial update rectangle, as was described previously. If multiple buffers are employed, a mechanism may be present so that updates may be applied to keep the buffers (e.g., more than one) up to date. Although claimed subject matter is not limited in scope in this respect, there may be one or more techniques so that memory may be conserved and/or number of updates may remain manageable. As one example, a display screen may be divided in a manner to create regions of a display with buffer updates taking place on a region-by-region basis. Likewise, in another embodiment, a single frame buffer may be employed, even in the presence of multiple buffers, as a mechanism so that a full frame may be more conveniently provided to a USB link during periods in which there are no frame updates.

One feature that may be desirable may include that user experience be maintained or at least not significantly degraded, where possible, even if available platform resources, such as CPU processing, may not be able to provide a full frame of fully processed display signals to be transmitted from a computer port, such as a USB port, at an appropriate time for purposes of external display, for example. Thus, in an embodiment, it may be desirable to elevate processing of display signals for transfer to an external device over other platform activities. This may be done, in an embodiment, for example, using a kernel thread to give priority to moving signals from VGA driver frame buffer(s) for further processing. However, updates to a frame buffer along with other platform activities may be lowered in priority as a result. Thus, in an embodiment, priority may be given to transmitting a frame or partial frame to an external device over processing new frames, for example. As a consequence, rather than underflows to an external device (e.g., missed service intervals), a reduction in effective frame rate may take place. A user may, therefore, see a repeated frame, instead of a blinking display, which may provide more graceful display degradation.

More graceful display degradation may likewise take place through a number of combined approaches and, therefore, claimed subject matter is not necessarily limited in scope to using only a particular single approach, although employing a particular approach may be included within claimed subject matter along with using a combination of approaches. For example, as explained in more detail below, an embodiment may at least partially employ at least partial dynamic management of bandwidth, such as via at least partial dynamic management of transmission of display signals, as explained in more detail below.

Thus, in at least one embodiment, a collection of mechanisms may be combined along with a heuristic process that has a capability to at least partially manage transmission of display signals along a communication path that includes a buffer smaller than a frame, such as a line buffer as shown in FIG. 2. To be more precise, given the potential for limited processing capability (and/or limitation of other platform capabilities), it may not be feasible at all times to deliver a full quality frame of display signals with sufficient timeliness for an external display. In some situations, this may also be the case due at least in part to relatively high quality display frames, such as from a high definition video, which may involve use of a reasonably significant bandwidth capability, as one example. Dynamic management of display signal transmission, however, performed at least in part may permit an approach to be implemented so that reasonable display quality may be maintained despite limited available platform resources. As discussed below, at least one of the following may be employed in connection with at least partial dynamic management of transmission of display signals: reducing display signal frame rate; employing display signal color compression; reducing display signal color depth; reducing display signal resolution, employing clipping of display signals or any combinations thereof. Thus, even if transmission path (e.g., communication channel) capacity reduces, sufficient display signals may continue to be transmitted and, likewise, as transmission path capacity reduces, sufficient display signals may continue to be transmitted. Furthermore, despite reduction in transmission path capacity, through at least partial dynamic management of transmission of display signals, a reasonably graceful reduction in display signal content may take place so that user experience remains at least reasonably acceptable.

As may be inferred, if sufficient platform resources are available, dynamic management of transmission of display signal, although available, may not need to be engaged. Thus, in an embodiment, initially, display signals may be delivered in a native format for a device generating display signals, if possible. However, constraints or limits on available resources potentially could lower quality of a user experience. Therefore, one approach may include monitoring available resources as resource demands in connection with processing of display signals may change. For example, as previously suggested, a heuristic process for monitoring both (e.g., available resources and demand for resources) and assessing likelihood of a shortfall may be employed. However, where available resources are more than adequate, a computing device may proceed unhindered with normal operation at least with respect to transmission of display signals.

Referring to FIG. 3, an embodiment 220 from FIG. 2 of a USB to VGA adapter, is described in more detail. Block 315 comprises a SuperSpeed PHY in this particular example embodiment. Here, PHY 315 provides connectivity to a USB host, such as computer 210 or other device. For this embodiment, PHY 315 supports 5 Gb/s SuperSpeed signaling as well as High-Speed, FullSpeed, and LowSpeed signaling compatible or compliant with an appropriate version of USB. For example, block 320 implements a USB Core, e.g., as for a USB2 device (e.g., compliant or compatible with USB2). By definition core 325 implements USB functionality. Besides signal transfer between a host computer and a display, as here, a USB core is typically capable of advertising features and/or capabilities.

Block 325 comprises a line buffer; although, again, claimed subject matter is not limited to this illustrative example. As mentioned, for example, a smaller buffer may be employed. Although line buffer 325 receives display signals, it is not entirely accurate to consider it simply a frame buffer replacement since it may perform operations that are typically desired even for adapters that employ a frame buffer. For example, line buffer 325 may address “imperfections” in signal rates between a host and a display, as described later.

Signals or stored memory states from PC 210 may be transferred from one or more frame buffers of a VGA driver to line buffer 325. For an embodiment, native ordering of signals provided may be employed. Thus, by default native non-FIFO type ordering may be employed. As states or stored signals are read from line buffer 325, reordering may take place to comply with an appropriate specification, such as VGA, for example. At this point, however, although stored signals (e.g., states) may relate to display signals, the signals or states may not yet be in display pixel format. For example, the states or signals may be compressed.

A next block, 330, referred to as a pixel generator, may convert signals to pixels. This block, thus, may perform decompression of compressed signals. A next bock, 335, referred to as a pixel formatter, may converts pixels to a format for triple digital to analog converter (DAC) input circuits of a display. For example, if pixels are in 16-bit mode, pixel formatter 335 may convert them to 24-bit pixels to be compatible with DAC 340. DAC 340 in this example embodiment comprises a Triple DAC. Thus, for example, DAC 340 takes Red/Green/Blue digital pixel values (e.g., three pixels in the range 0-255) and outputs a corresponding analog signal to a VGA connector to drive a VGA monitor. Additional blocks shown may provide various other system functions that need not be discussed for purposes of comprehending presently claimed subject matter.

Thus, for an embodiment, as illustrated and described, a pipeline is formed such that, with sufficient available resources, a frame buffer of display signals may be transmitted using a line buffer. In other words, in an embodiment, line by line, a frame of display signals may be delivered to display 230 in a manner so that user experience is not substantially different than if a frame buffer had been employed, but without use of a frame buffer. Although timing may be appropriately handled to accomplish this result, with sufficient available platform resources and using, in this embodiment, USB3, a line buffer of sufficient size, such as 64 Kbyte or perhaps a buffer of smaller size, may be adequate.

If available bandwidth (e.g., throughput) resources drop below demand, as mentioned, a heuristic process may be performed. Thus, in an embodiment, it may be desirable to monitor both of these (e.g., resource availability and resource demand) as operation of the devices proceeds. A convenient way to determine demand may be to evaluate throughput for a display frame of binary digital signals (e.g., bits). If we consider the amount of bits for a typical single display frame (for example, 6 MB) and multiply it by a typical frame rate (for example 60 FPS), this would suggest a bandwidth or throughput demand of 360 MB/sec.

A similar evaluation of platform resources is possible. However, a variety of approaches may be employed. For example, a user may select an amount of platform resources to allocate or a platform may itself allocate an amount of platform resources for such processing, such as 100 MB/s to process display signals, for example. As another approach, a calculation by a device driver, for example, may determine dynamically a signaling transfer rate achieved via a USB bus over a previous time interval or an effective frame rate of a display stack.

Thus, a heuristic, in an embodiment, may estimate bandwidth (e.g., throughput) demands and available bandwidth (e.g., throughput) platform resources. If demand exceeds amount available, a heuristic process, in an embodiment, may execute various potential approaches to bring back substantial alignment of these values, as described in more detail below. Likewise, monitoring continues so that as resources free up and/or demand goes down such that demand may no longer exceed availability, user experience may likewise be adjusted and improved by reversing some actions executed by a heuristic and return to a higher level of display signal delivery.

As mentioned previously, for an embodiment, for example, display frame rate may be reduced, which would, thereby, reduce throughput demand. One way to reduce display frame rate may be to reduce physical display frame rate, which would effectively reduce signal throughput demand. For example, reducing from 60 FPS to 50 FPS for HD1080P, for example, may reduce demand from 356 MB/s to 297 MB/s according to calculations. Likewise, most displays that support 1080P 60 also support 1080P 50 since they employ a common clock rate. Furthermore, perceptible loss in user experience may be quite low, if any loss is perceived at all.

Another way to reduce display frame rate may be via a system software stack of a device, such as PC 210, for example. If, for example, a system has resource limitations that are not necessarily associated with high USB bandwidth delivery demand but, instead, may relate more to limited CPU and/or GPU resources, reducing rate of frame processing for a system may be desirable. While this may be achieved by a reduction applied to a physical display, as discussed, it may also be useful to separate physical display refresh rate from system frame rate. Advantages may include less disruptive changes and/or greater flexibility than changes to display hardware, for example. For instance, while as discussed, we may reduce a display to 1080P 50 FPS, alternatively or in addition, we could reduce frame rate to 24 FPS. From calculations, the former would, as an illustrative non-limiting example, reduce USB bandwidth by 16%; by contrast, the latter would reduce system CPU/GPU bandwidth by more than 50%, providing greater savings in terms of use of available resources.

As previously mentioned, another approach to reducing consumption of available platform resources may include use of compression, in an embodiment, for example, display signal color compression. There are many types of compression that are in common use. A compression approach that is “light weight” in terms of the hardware overhead for implementing compression and/or decompression may be desirable. Thus, although claimed subject matter is not limited in scope in this respect, in an embodiment, as an example, run-length encoded linear compression may be employed.

Run-length encoding type compression typically performs well under various usage cases, such as for Microsoft Office or Microsoft Windows type applications. For video content, although not performing quite as well, nonetheless, amount of resulting compression may be adequate, such as rough around 23-30% compression. Furthermore, run length compression is relatively easy to implement with little additional hardware cost typically. One aspect of employing compression, of course, is that compressed content should not exceed uncompressed content in terms of storage (e.g., size). Although this may be accomplished a number of potential ways, in one embodiment, one bit of color depth may be used as a flag to signal undesirable situations for compression, such as where compressed content may exceed uncompressed content. While this may not as efficient as some other possible approaches, it may lead to relatively simple hardware implementation.

In some cases, however, it may be desirable to achieve even greater color compression than may result from the previously described approaches. If so, another approach to increase compressibility of display content may comprise reducing display signal color depth. As an example, employing compression in situations where a “run” of pixels has “similar” color rather than identical color may result in greater compression. In an embodiment, a simple mask, for example, may effectively control similarity of pixel color for compression of a run. For example, to compress a 24-bit image, the top 6 bits of an 8-bit RGB component may be matched, while the least significant 2 bits may be ignored for consecutive pixels. Of course, this is one non-limiting illustrative example. Claimed subject matter is not intended to be limited to illustrative examples.

However, a potential advantage includes a capability to gradually tune or adjust compressibility. Loss of accuracy takes place since, for an embodiment, a single pixel value may be chosen to represent a longer run than otherwise in terms of color. However, color adjustment may be controlled at least partially via software substantially in accordance with a separate heuristic in an embodiment. For ease of implementation and potentially greater efficiency, an embodiment may employ a color of a first pixel to represent a pixel run. This normally works reasonably well, however, there is one notable case for which an exception may be made for an embodiment. This exception leads to a process referred to here as “gravity mode” compression.

As described for the embodiment above, color accuracy may be adjusted by tuning of an accuracy mask; however, color accuracy adjustment may potentially produce a distinct undesirable artifact for a displayed image. For example, in some situations, a color trail may appear to the right of another object. A trail of a mouse pointer, as one example, might appear. If a compression process were to start a run on one of the right-edge pixels of a mouse pointer, if this pixel were a close (but imperfect) match for background color of a display, an imperfect color run would continue for the rest of a display line (unless interrupted by another object), producing a noticeable color trail effect. To address this, another heuristic may be added that if two immediately adjacent pixels in a run have an exact color match, a color pixel run for color compression starts with the immediately adjacent pixel pair, as if snapping to the “gravity” of the color of the pixel pair.

There are also some extensions of linear run length compression that may be employed in an embodiment. For example, a bi-linear extension may comprise a generalization of horizontal run lengths to include vertical run lengths so that two runs (e.g., horizontal and vertical) may be to be described using a single pixel value to represent color of a rectangular portion of a display. However, implementing a vertical run component may typically involve more hardware than implementing a horizontal run component. For example, in an embodiment, to take advantage of a vertical run may typically involve storage on a display, for example, to store vertical runs until it is time for display, as horizontal lines are successively drawn, for example. In contrast, for horizontal runs a counter may be employed to keep track of a single horizontal run which is active at any given time. By combining horizontal and vertical run lengths into a single pixel, as mentioned, color rectangles result. A hardware addition for storage, as indicated, may be on the order of a single horizontal line of frame buffer (e.g., 4 Kbytes of RAM) in an embodiment, for example, which may be tolerable for an embodiment. Another generalization might include frame-based compression in which, without immediate adjacency, repeated values may be compressed in an approach similar to run length encoding.

In addition to color compression, another approach to reducing throughput demand for a given display mode may include reducing number of bits used to represent a pixel. The highest level of color accuracy currently supported comprises 24 bits. However, hardware usually also supports 16 and 8 bit color modes. A 16 bit color mode, for example, may provide passable quality for non-video type applications. While an 8 bit color mode may present a less appealing user experience, it may nonetheless be useful to drive a meaningful display if throughput resources are simply not available (e.g., it may be better than a flickering display or a non-functional display from a user perspective).

Furthermore, in an embodiment, a special color palette mode may be added to enhance 8-bit performance, which may also be useful for USB2 backwards compatibility modes. A palette may allow 256 colors available in 8-bit mode to be mapped to an arbitrary set of 256 24-bit colors. By using multiple palettes, different portions of a display, for instance, may reference different palettes. In this way, it may be possible to maintain 24-bit color accuracy for a pixel, for example, but reference these colors with 8 or even fewer bits per pixel, resulting in improved compression. Furthermore, color format may be changed dynamically on a frame by frame basis, referred to here has dynamic compression, and may be adjusted in conjunction with color compression. Thus, in an embodiment, for example, if color accuracy were reduced from 23 bits per-pixel down to 15 bits per pixel (e.g., also using one bit of color depth as a flag, as previously described), a heuristic may transmit display frames in a 16 bit pixel format, since to do so at that point would not result in further loss of color depth, although some color shifting may occur. Likewise, as additional system throughput resources become available, color accuracy may be adjusted upward also resulting in moving pixel format back to 24 bit mode, for example.

Yet another approach for reducing system throughput demand of a display may be to reduce display resolution. This may reduce demand in a more fundamental way by reducing number of pixels in a frame to be displayed. An advantage includes that display hardware and/or software are generally designed to do a reasonable job of scaling content to a smaller resolution. However, a disadvantage may be that changes of resolution are more likely to be disruptive to user experience.

Therefore, although claimed subject matter is not limited in scope in this respect, it may be appropriate to reduce pixel resolution at particular points during display usage, such as at the beginning of full-screen video playback, for example. In this manner, a user may experience a noticeable change at the start of, for example, a movie and another at the end, but does not have a viewing experience potentially adversely affected by content-related pixel resolution toggling. In another embodiment, a similar approach may relate to handling of display signals for a large format display, for example (e.g., 1920×1080). For typically Microsoft Office type applications, for example, relatively modest bandwidth (e.g., 40 MB/sec) may provide adequate throughput; however, a display could “dynamically” switch to a lower resolution (e.g., 1024×768) for video playback. Although a user may not experience HD video playback, a user may still enjoy a spacious desktop for business applications, such as for a 3^{rd} or 4^{th} display that may be added a system, as an example.

Still another approach may be used in extreme situations of throughput sufficiently limited that it may not generally be feasible to support transmission of display signals to an external display. As mentioned previously, a desirable feature may be to provide an improved user experience, by adjustments of available resources, throughput demands or both, even in circumstances in which throughput may be more severely limited. Thus, it may bedesirable to consider a heuristic for a situation where, despite approaches previously described in combination (or similar approaches), it nonetheless is still infeasible to transmit sufficient display frame signals to produce a changing display image that is visually recognizable and/or satisfactory, for example. Thus, in this example, USB bandwidth is assumed to be oversubscribed. In this case, in an embodiment, a heuristic may, therefore, implement a form of display clipping. Although analogous to compression since very few signals, if any, may be transmitted, in an embodiment, an approach of display clipping may be considered distinct from compression in that it does not involve decompression processing to produce a frame different from a previously transmitted frame.

Display clipping may take a variety of forms and it is intended that claimed subject matter include all of them. For example, replay of an existing frame, but at lower frame rates, for example, may take place. Alternatively, a single pixel color may be transmitted and shown on over a display frame. Another choice might be to draw horizontal lines with an average pixel value for that respective line. Thus, in an embodiment, display clipping may comprise, for example, a transition from a full display frame to an approximation of a full display frame that may be represented in a single 1K USB3 packet, for example. There are many such possible choices for a smooth transition into and out of what may be considered “outages” in a USB3 link as a result of link over-subscription.

Up to this point, embodiments have been described in which bulk signal transfers take place; however, despite desirability of bulk transfer approaches, situations may occur in which bulk transfer of display signals is not a feasible option. For such situations, another approach to dynamic management of transmission of display signals than previously described may be employed. In particular, USB, for example, makes available an isochronous (referred to herein as ISOCH) mode of signal transfer.

A typical example of a situation in which ISOCH mode may be appropriate includes a situation in which no feasible method is readily available to prioritize among multiple bulk streams. For example, if an external SuperSpeed hard drive were placed behind a USB hub along with a display device, the display and the hard drive would be viewed as equivalent in terms of priority of receiving signal transmissions. Thus, in this example, assuming a large backup starts to a hard drive, a backup signal transfer may compete with signal transfer to a display. Although approaches, such as those previously described, in an embodiment, may attempt to adjust, if they are unable to do so adequately, without another approach to such a situation, the display may undesirably flicker and/or blink.

As mentioned, USB offers ISOCH mode as an option. ISOCH traffic refers to signal traffic that is known to have a certain desired throughput for time-sensitive signals. If a system discovers an isochronous endpoint, the endpoint advertises one or more profiles under which it is able to operate. A profile generally comprises a servicing interval (e.g., latency) and a signal amount per interval (e.g., throughput). A system (e.g., platform) may look at available resources on a particular USB port and select a profile that is able to be supported. If no advertised profile is able to be supported, the component may be rejected. If a profile is accepted by a platform, a service contract is executed so that USB components operate to comply with the service contract during system operation. So, in this illustrative example, an isochronous display endpoint would have a service contract for a particular throughput. In a service interval, using the prior example, a display would be serviced before giving USB bandwidth to a disk drive. Complete starvation of, for example, a disk drive in this situation, is less likely by an isochronous contract that does consume all available bandwidth. Under this scenario, a USB display and a hard drive behind the same hub are intended to transfer signals without interference as a result of competing throughput demands.

However, if a display is operating in ISOCH mode, some form of at least partial dynamic management of transmission of display signals may be desirable. Otherwise, throughput demands may exceed throughput availability, as discussed previously. One of the issues with isochronous mode is that it is generally directed to fixed rate devices. While at a macro level, a display may be considered a fixed rate device, that may in practice be considered an oversimplification. For example, in operation, display signals may be read out of a line buffer substantially in accordance with a frequency of a pixel clock, which may be independent of a clock used to write signals into a buffer, such as a line buffer, since, for example, typically, a clock to write to a buffer may be derived from a USB clock of a driving device, such as computer 210. Thus, a mismatch between a rate to read and a rate to write may exist such that underflow or overflow may potentially result in a buffer (e.g., a line buffer, as was described) unless addressed in some way.

In addition, VGA displays work substantially in accordance with raster beam technology. Thus, timing, and, hence, management of signal throughput may be an issue, since raster beam technology involves a variety of horizontal and vertical blanking intervals, which are more likely to affect an ability of a display to process signals. Isochronous signal packets are, in general, scheduled with reference to 125 uS intervals in SuperSpeed USB. Therefore, without some type of dynamic management of transmission of display signals, these intervals may not correspond with appropriate active display intervals associated with raster beam technology. Furthermore, as mentioned earlier, there is also a clock mismatch between a display clock that may be reading from a line buffer, for example, and a USB clock that may be writing to a line buffer. A combination of these two factors may, therefore, affect sizing of a buffer to provide adequate margin while attempting, through dynamic management of transmission of display signals, to closely resemble raster beam timing of a display.

Several mechanisms are available to dynamically manage isochronous display signal transmission; however, as alluded to above, two aspects in an embodiment may be particularly considered. One aspect relates to at least partially accounting for display raster beam timing; whereas another aspect relate to dynamically managing isochronous display rate synchronization. In at least one embodiment, as described later, display rate synchronization may also provide a capability to address handling of clock mismatch.

At least implicitly, as alluded to, rate matching between USB signal packets and consumption of display signals by a VGA device may be desirable in an embodiment. Beginning with a typical 60 Hz display frequency, in an example embodiment, every second, with a 60 Hz refresh rate, there will be 60 frames to be transmitted. Likewise, in ISOCH mode, continuing with an example, there will be 8000 USB microframe intervals (e.g., 125 uS per interval) delineated by ITPs (Isochronous Timestamp Packets). Thus, there will be 1 video frame per 133.33 USB microframes in this example.

There are several options for scheduling isochronous transfer for this example. One possible approach may be to adjust video refresh rate timing to 60.15 Hz so a single frame corresponds to 133 USB microframes. In this example, one could divide a display frame payload number of bytes by 133 and setup a transfer of that amount per microframe. Likely, however, the number of bytes may not divide evenly, potentially resulting in a round up by one with 133^{rd} transfer providing a residual number of remaining bytes.

This latter approach, however, has some potential disadvantages. Skewing frame timing from 60 Hz to 60.15 Hz may introduce compatibility issues for some displays. A similar issue may also exist with other refresh rates, like 72 Hz, 75 Hz, 85 Hz, 120 Hz, etc. Further, as alluded to in connection with discussion of raster beam technology, display signals are not necessarily intended to be delivered to a display uniformly during a time period allocated for processing a display frame. For example, there are vertical and horizontal blanking times, etc., as a frame is drawn on a display. Nonetheless, horizontal blanking time is per line, and, therefore, is orders of magnitude less than vertical blanking time, which is per frame.

Thus, in an embodiment, vertical blanking time may be addressed through dynamic management of transmission of display signals, whereas horizontal blanking time may be addressed through buffering, as shall become more clear below. For an embodiment, the following repetitive process may generally be used accomplish both, as explained in more detail:
1—Start signal transmission using a specific time synchronization marker.
2—Deliver display signals at a rate that meets or slightly exceeds a number of pixels per USB microframe corresponding to a time-averaged number of pixels that are to be displayed (again, using a per USB microframe basis).
3—Preload a buffer with a target number of pixels during a vertical blanking time to reduce risk of underflow and/or overflow of the buffer during active display time.
4—Repeat delivery of display signals in a pattern that continues to meet 2 and 3 above.

Operation one, above, in an embodiment may be met by programming a display to begin display timing at a selected time (e.g., Isochronous Time Stamp or ITP) or by using an initial signal packet to start display timing, such as a packet with an empty payload, as a non-limiting example.

Operation two, above, in an embodiment, may be met via a calculation of appropriate display signal delivery rate. For example, assume Hactive*Vtotal represents number of displayed pixels if there were no vertical blanking duration (e.g., number of pixels that would be written in a horizontal lines sweep multiplied by number of lines in a vertical sweep). Multiplying by RefreshRate (e.g., video frames per second) and dividing by 8000 (e.g., microframes per second) results in a number of pixels to be transferred per microframe during active display time, substantially in accordance with the following relation (1):

uFramePixels=Hactive*Vtotal*RefreshRate/8000 (1)

An embodiment may round up to a system cache line size or other system block size or a multiple thereof for more efficient memory state transfer within a computer system, although claimed subject matter is not limited in scope in this respect.

During a display frame, however, number of pixels actually displayed (e.g. taking into account vertical blanking time) may be represented as Hactive*Vactive, meaning that, in terms of number of pixels or pixel time, for (Vtotal-Vactive)*Hactive, a USB bus may not perform display signal deliver as a result of vertical blanking. This time may, for example, be divided in a variety of ways, such as to be before and after active video display time (with respect to USB microframe timing) or a “USB bus blanking time” may be fully prepended or fully appended to a synchronization marker, such as a marker generated in operation one. For illustration here, assume a full USB bus blanking time proceeds an active video frame time; although claimed subject matter is not limited in scope to an illustration. This simplification may be introduced for illustration and may later be relaxed in an embodiment, for example.

Operation three suggests a prefill of buffer to a target specified level before active pixel display time to provide some buffer margin for potential irregularities in display signal delivery. Within a microframe (e.g., 125 us) signal packets containing display signals may be sent at the beginning of a microframe (e.g., immediately following ITP) or end of a microframe (e.g., preceeding next ITP) or anywhere in between. For this embodiment, assume a target buffer depth at the instant display signal delivery begins for another frame comprises one (1) USB microframe worth or uFramePixels (e.g., substantially in accordance with relation (1) above). Other embodiments could select more or fewer display signals for a prefill target depth and/or could even use a programmable and/or tunable value

For operation three, above, there is a blanking time or interval of (Vtotal−Vactive)*Hactive in units of display signal pixels, during which a buffer may be pre-filled, as previously described, for an embodiment. Converting to a number of USB blanking interval microframes, which may be empty, may be calculated substantially in accordance with the following relation (2):

uFramesEmpty1=(Vtotal−Vactive)*Hactive/uFramePixels−1 (2)

The calculation result may be a fraction. Thus, an embodiment may, for example, round down to a nearest whole integer to obtain a number of USB microframes to insert after a time synchronization marker of operation one. One is subtracted above as a result of a target prefill depth before a display frame begins to dispatch.

After empty frames may be transmitted, to comply with operation two, uFramePixels per USB microframe may be transmitted until Hactive*Vactive display signal pixels are finished (e.g., one full display frame). An embodiment may further refine a number of bytes sent in initial non-empty USB microframes. Instead of starting with uFramePixels, an embodiment may, for example, scale proportionally by a fractional remainder in uFrameEmpty1, substantially in accordance with the following relation (3):

uFramePixels1_{—}1=uFramePixels*(uFramesEmpty1−rounddown(uFramesEmpty1)) (3)

An embodiment may, therefore, after sending uFramePixels1_{—}1 following empty microframes, continue sending uFramePixels per USB microframes until Hactive*Vactive display signal pixels may be delivered. Again, this particular illustrative embodiment demonstrates a pre-fill level of uFramePixels. If another value were chosen, adjustment of calculations (e.g., uFramesEmpty, calculation of empty microfraems, and, uFramePixels1, calculation of an initial microframe signal delivery) would be appropriate. Claimed subject matter is likewise not intended to be limited to a particular illustrative example or embodiment.

For an embodiment, operation four may be met by repetition of USB empty and non-empty microframes to continue to deliver display signals in time for successive display frames although USB microframe ITPs may not be coincident with display frame timing in successive display frames.

A whole number of USB microframes may be computed substantially in accordance with relations (4) as follows:

numUFrames1=8000/RefreshRate

numUFramesWhole1=rounddown(numUFrames1)

numUFramesPart1=numUFrames1−numUFramesWhole1

Successive numbers of USB microframes may be determined by carrying forward a remainder substantially in accordance with relations (5) as follows, in an embodiment:

numUFrames2=8000/RefreshRate+numUFramesPart1

numUFramesWhole2=rounddown(numUFrames2)

numUFramesPart2=numUFrames2−numUFramesWhole2

numUFrames3=8000/RefreshRate+numUFramesPart2

numUFramesWhole3=rounddown(numUFrames3)

numUFramesPart3=numUFrames3−numUFramesWhole3

. . . .

With a remainder in terms of USB microframes from one display frame to the next, a number of empty microframes and uFramePixels1 (e.g., an initial microframe signal delivery) may a carryover substantially in accordance with relations (6) and relations (7) as follows, for an embodiment:

uFramesEmpty2=(Vtotal−Vactive)*Hactive/uFramePixels+numUFramesPart1

uFramesEmpty3=(Vtotal−Vactive)*Hactive/uFramePixels+numUFramesPart2

. . . .

For relations (7), immediately below, it may be worth noting for this embodiment that one is not subtracted, unlike in relation (2) shown and discussed above, since initial USB display signal pixel dispatch is anchored ahead of a display driver.

uFramePixels1_{—}2=uFramePixels*(uFramesEmpty2−rounddown(uFramesEmpty2))

uFramePixels1_{—}3=uFramePixels*(uFramesEmpty3−rounddown(uFramesEmpty3))

. . . .

Repetitive delivery, as discussed for operation four, for example, in an embodiment, may produce accumulated round off error over time if divisions are employed. An embodiment, however, may scale units (e.g., by an 8000× in factor relation (1) above) and consider numUFrames in terms of relative number of display signal pixels to address risk of accumulated round off error.

An example of display frame transfer via USB microframes for ISOCH mode with 1920×1080@60 Hz is shown below as an illustration. Also, for this example, vertical blanking, as was discussed as a possible embodiment, is shown as divided before and after active video display time. This sequence may repeat every 3 video frames (400 USB microframes) in accordance with a 60 Hz rate relative ratio of the time domains, in this example.

| | | |
|---|---|---|
| Video Frame 1 | Video Frame 2 | Video Frame 3 |

| USB | Bytes- | USB | Bytes- | USB | Bytes- |
|---|---|---|---|---|---|
| Frame # | Sending | Frame # | Sending | Frame # | Sending |
| 1 | 0 | 135 | 0 | 268 | 0 |
| 2 | 0 | 136 | 0 | 269 | 0 |
| 3 | 0 | 137 | 0 | 270 | 0 |
| 4 | 6848 | 138 | 39248 | 271 | 23040 |
| 5 | 48608 | 139 | 48608 | 272 | 48608 |
| 6 | 48608 | 140 | 48608 | 273 | 48608 |
| 7 | 48608 | 141 | 48608 | 274 | 48608 |
| 8 | 48608 | 142 | 48608 | 275 | 48608 |
| . . . | 48608 | . . . | 48608 | . . . | 48608 |
| 130 | 48608 | 264 | 48608 | 397 | 48608 |
| 131 | 48608 | 265 | 48608 | 398 | 48608 |
| 132 | 40736 | 266 | 8336 | 399 | 24544 |
| 133 | 0 | 267 | 0 | 400 | 0 |
| 134 | 0 | | | | |

In an embodiment, a mechanism, as described above, may be employed to at least partially account for display raster beam timing; whereas below, mechanisms are described for an embodiment to dynamically manage isochronous display rate synchronization.

For example, alignment between USB microframes and a display frame duration may be possible by skewing Isochronous Timestamp Packet (ITP) timing of a host, such as computer 230. A mechanism in the Superspeed USB specification called Bus Interval Adjust (BIA) device notification allows a single device in a system to request ITP rate adjustment by +/−1066 ppm. However, “ownership” of USB host ITP adjustment is currently assigned on a first come, first served basis, so this mechanism may not be available in all cases, unfortunately. Nonetheless, if available, it may permit relative simplicity of operation in that a pattern of delivered signal packets may be a fixed, and an application driver does not need to alter or modulate a dispatch schedule from frame to frame to make a synchronization adjustment with a display, for example.

FIG. 4 is a schematic diagram illustrating an embodiment of a Bus Interval Adjustment (BIA) mechanism between a USB Host, such as computer 230, and a USB Device, such as USB to VGA adapter 220. Furthermore, upper level layers of a host system, such as a bus driver or a display driver, may not be involved for adjustment. Thus, adapter 220, for example, may perform a computation and notify a USB host, such as 230, for appropriate adjustment to take place.

Continuing with our prior example, every second, as an illustration, at a 60 Hz refresh rate, there will be 60 display frames and 8000 USB microframe intervals, delineated by ITPs, may be transmissed. As described previously, divided up evenly that produces 1 display frame to 133.33 USB microframes. Thus, a simple approach for 60 Hz may be, as an example, adjusting refresh rate to 60.15 Hz so a display frame may align with 133 USB microframes. Yet, another option may be to use a greatest common factor computation to recognize that 3 video frames at 60 Hz aligns with 400 USB microframes. Both are viable approaches, but the second may be more precise and appears to, therefore, not compromise refresh rate. As an illustrative example, a common factor approach is discussed below. Other refresh rates such as 72 Hz, 75 Hz, 85 Hz, 120 Hz, etc. may also be viable in which a ratio of frames to USB microframes may be adjust based at least in part upon a greatest common factor of 8000 and a given refresh rate.

An ITP rate adjust limit is +/−1066 ppm meaning that accuracy of a host device and a refresh rate for a display should be within these bounds for adequate performance. In accordance with the USB specification, a USB host may provide better than 500 ppm accuracy for interval timing. This leaves 566 ppm of accuracy for a refresh rate to be within a range addressable by BIA. Refresh rates within 566 ppm of target for display modes of interest are possible under appropriate circumstances, as described below.

FIG. 5 is a schematic diagram demonstrating drift occurring between relative alignment of USB ITP markers and a display frame start. Compensating for drift may typically involve measuring an offset and a computation to report a desired change to a USB host via a BIA device notification to substantially maintain frame alignment with further USB bus intervals.

On an initial display frame, a measurement, T₀, may be made of an offset. It is desirable for offset between display frames and USB ITP markers to remain substantially constant. BIA device notification rate is once per display frame starting with a measured error on a second display frame in this embodiment. Also in some implementations, it might be reasonable to choose less frequent intervals to make adjustments, which may smooth (e.g., reduce) jitter.

In an example embodiment, error computation may repeat every U_{f}_{_{—}}ₘᵢₙ USB microframes or Vᵣ_{_{—}}ₘᵢₙ video frames, whichever may occur later, for an example embodiment. Error may be computed substantially in accordance with the following relation (8):

ERRₘ=Tₘ−T₀ (8)

Similarly, error for previous intervals may be computed substantially in accordance with the following relation (9). This computation may useful to determine a rate of closure to dampen overshoot/undershoot, as discussed later.

ERRₘ₋₁=Tₘ₋₁−T₀ (9)

Units of T₀, Tₘ, Tₘ₋₁ in this example may be in terms of 60 MHz clock cycles, which for an embodiment may make for a realizable hardware implementation, since 60 Mhz clocks are readily available in USB systems and it factors easily into a BIA offset computation in accordance with the following relation (10), for an embodiment:

ERRBIAₘ=ERRₘ*4096/U_{f}_{_{—}}ₘᵢₙ (10)

Further, two dampening factors Fₚ and F_{d} may be introduced. Fₚ may comprise a factor for an error portion to compensate and F_{d} may comprise a factor for error delta to compensate. In an embodiment, rather than immediately adjusting for 100% of measured error, simple factors such as 1, 2, 4, etc. may be programmed to more slowly adjust ITP and, thereby, potentially reduce jitter of a BIA value.

In an embodiment, a BIA value may be computed substantially in accordance with the following relation (11):

$$B I A = \frac{4096 * ( \frac{{ERR}_{m}}{{F}_{p}} + \frac{{ERR}_{m} - {ERR}_{m - 1}}{{F}_{d}} )}{{U}_{f\_min}} \qquad ( 11 )$$

However, on an initial BIA adjustment, after display rendering begins, let ERRₘ=ERRₘ₋₁

The USB SuperSpeed specification states that accumulated BIA shall not exceed +/−32768 and no single adjustment shall be more than 4096 or less than −4096. Therefore, a BIA value may be limited to abide by the specification. In an embodiment, if the first constraint just mentioned reached, exceeding +/−32768, an error flag may be set to indicate an adjustment greater than +/−1066 ppm is desired to maintain USB microframe and display frame alignment.

An embodiment, such as described above, may accelerate or retard an ITP rate according to an initially measured offset, T₀. In an alternate embodiment, an adjustment may be derived using trends in buffer utilization for a display, for example.

Another mechanism to dynamically managing isochronous display rate synchronization is referred to as Isoch Display Rate Interval Synchronization. In an embodiment, increases or decreases in a number of USB microframes per display frame by fractional amounts may be possible. For an embodiment, adjusting number of microframes per display frame is mutually exclusive with the previous Isoch Display Rate Interval Synchronization approach, discussed immediately above. However, an advantage over adjusting a BIA value may the potential to address mismatch between USB host clock timing, which generates USB microframes, and a generated clock within a display adapter, for example.

As previously described, in an embodiment, in ISOCH mode, a display frame may be distributed over USB microframes. As an extension, in an embodiment, an iterator increment variable uFramePixels may be attenuated substantially in accordance with an Isoch feedback endpoint packet. Changing a uFramePixels increment may not generate an immediate adjustment, but, over time, fractional adjustments may result in an extra blank USB microframe to be added or removed, thus affecting a time-averaged signal delivery rate.

In an embodiment, this approach has several potential advantages, such as: not limited to a single resource, useful for USB 3.0 and USB 2.0, and permitting adjustments beyond +/−1066 pp. Simulation results, for example, indicate it should work well even past +/−5000 ppm, for example. However, a potential disadvantage is that a slow reaction time may introduce delay, as discussed in more below. Nonetheless, claimed subject matter is not limited to advantages or disadvantages, which may vary with a particular embodiment, of course.

FIG. 6 is a schematic diagram illustrating a feedback approach to display synchronization adjustment for an embodiment through fractional adjustment of microframes per display frame. Display frames from a system may be partitioned into USB microframe-sized transfers accordingly, in a Video Frame Partition and Queue block 610, for example, illustrated in FIG. 6. Display signals and values from a USB feedback endpoint for uFramePixels amounts may be encoded into a packet format using methods, such as previously described for an embodiment, for example.

In an embodiment, a byte count uFramePixels*bytesPerPixel in a payload of a feedback endpoint packet may be employed substantially in compliance with the USB specification. In another embodiment, a feedback endpoint packet payload may include a proprietary numerical indication using, for example, state information of a display device (e.g., buffering levels, time delay measurement, etc.) to accelerate or slow a rate of delivery, computation of which may become part of a USB display device driver, in an embodiment.

As illustrated in FIG. 6, USB Feedback messages dispatched to a Video Frame Partition and Queue block 610 may take several frames to take effect, based at least in part upon a delay of a device driver and/or based at least in part on display frames already in a queue and patterned. Feedback delay compensation may, however, be at least partially handled in an embodiment. A computation frequency may, for example, in an embodiment, be made longer than a feedback delay so a change in microframes is capable of being observed. Likewise, in an embodiment, sizing of USB Display Device buffers and selecting a target fill level sufficient to manage risk of underrun/overrun while feedback takes effect may also be employed, as described below

FIG. 7 shows uFramePixels*bytesPerPixel (TD-Bytes) on a y-axis with number of frames on an X-axis for a +1100 ppm offset pixel clock period for a 1920×1080@60 Hz example, also used previously. After a few hundred frames, it is noted that rate stabilizes with relatively small jitter.

FIG. 8 shows peaks and valleys of a USB display device buffer. Likewise, it is noted initially buffer overruns and under-runs take place before stabilizing. It is not economical to size a USB display buffer for over and/or under runs. However, several approaches may be employed in different embodiments. In one embodiment, for example, display output may be masked until a feedback loop becomes sufficiently stable so that risk of an underrun/overrun of a buffer memory is sufficiently low to be acceptable. In another embodiment, calibration counters may be employed to preload an initial feedback loop value.

Numerous methods may be employed to compute uFramePixels, including but not limited to peak buffer usage monitoring of a display device buffer or frame start measure T₀, according to FIG. 9, which is analogous to FIG. 5, described previously. An embodiment may employ feedback compensation to lock T₀ to 1 USB microframe, for example. In FIG. 9, T₀ is less than 1 USB microframe, so uFramePixels may increase to move a delivery start to earlier. Increasing uFramePixels may eventually result in a T₀ gap increasing to a point where it exceeds 1 microframe, jumping to 2 microframes, which would suggest a decrease in uFramePixels to adjust a T₀ gap back to 1 microframe. This oscillation or jitter is functionally sound and is realized as an embodiment; however, as another embodiment, one may consider TD₀ as a fraction of TD_{N} relative to T₀.

Assume a nominal display frame payload is distributed over a USB microframe. With that being the case, the number of bytes at the start of a frame in a USB display device buffer is substantially in accordance with the following relation (12):

$${BUFF}_{0} = {TD}_{0 -} \frac{{T}_{0} * {TD}_{N}}{7500} \qquad ( 12 )$$

In this embodiment, T₀ is measured in 60 MHz clock intervals and 7500 is the number of 60 Mhz clock cycles per USB microframe. A variable may be introduced, BUFF_{T}, which comprises number of bytes targeted to be in a display buffer at the start of an active frame. In an embodiment, this may correspond to a target buffer pre-fill level criteria, as previously described. A measured error in bytes may, therefore, be substantially in accordance with the following relation (13):

ERRₘ=BUFF_{T}−BUFF₀ (13)

It was also previously noted that error may be computed less frequently than every frame in an embodiment. Thus, in an embodiment, another variable may be introduced, FBᵣₐₜₑ, for number of frames between adjustments such that a value is larger than feedback delay of the system in terms of number of frames. In an embodiment, FBᵣₐₜₑ may be programmable and may be tailored to a worst case feedback delay, if desired.

Since error in an embodiment may be measured less frequently, it may be scaled to distribute over FBᵣₐₜₑ frames and converted to USB microframes substantially in accordance with the following factor as given by (14):

$$\frac{REFRESH}{8000 * {FB}_{rate}} \qquad ( 14 )$$

Further, similar to previously, two dampening factors Fₚ and F_{d} may be introduced in an embodiment. Fₚ may comprise a factor of an error portion to compensate and F_{d} may comprise a factor of an error delta to compensate. As mentioned previously, for an embodiment, rather than immediately adjusting for 100% of error, an embodiment may include an option to program simple factors such as 1, 2, 4, etc. to more slowly adjust and potentially reduce resultant jitter. In an embodiment, one may compute a TD_{N}(new) from a present TD_{N} to be signaled via a feedback endpoint substantially in accordance with the following relation (15):

$${TD}_{N} ( new ) = {TD}_{N} + \frac{{ERR}_{m}}{{F}_{P} * 8000 * {FB}_{rate}} + \frac{{ERR}_{m} - {ERR}_{m - 1}}{{F}_{D} * 8000 * {FB}_{rate}} \qquad ( 15 )$$

where ERRₘ₋₁ comprises a previous error measure of FBᵣₐₜₑ frames, except for an initial computation where ERRₘ₋₁=ERRₘ may be employed.

For purposes of illustration, FIG. 10 is an illustration of an embodiment of a computing platform or computing device 410 that may be employed in a client-server type interaction, such as described. In FIG. 10, server 400 may interface with a client 410, which may comprise features of a conventional client device, for example. Communications interface 420, processor (e.g., processing unit) 450, and memory 470, which may comprise primary memory 474 and secondary memory 476, may communicate by way of communication bus 440, for example. In FIG. 10, client 410 may store various forms of content, such as analog, uncompressed digital, lossless compressed digital, or lossy compressed digital formats for content of various types, such as video, imaging, text, audio, etc. in the form physical states or signals, for example. Client 410 may communicate with server 400 by way of an Internet connection via network 415, for example. Although the computing platforms (e.g., 400, 410) of FIG. 10 shows the above-identified components, claimed subject matter is not limited to computing platforms having only these components as other implementations may include alternative arrangements that may comprise additional components, fewer components, or components that function differently while achieving similar results. Rather, examples are provided merely as illustrations. It is not intended that claimed subject matter to limited in scope to illustrative examples.

Processor 450 may be representative of one or more circuits, such as digital circuits, to perform at least a portion of a computing procedure or process. By way of example but not limitation, processor 450 may comprise one or more processors, such as controllers, microprocessors, microcontrollers, application specific integrated circuits, digital signal processors, programmable logic devices, field programmable gate arrays, and the like, or any combination thereof. In implementations, processor 450 may perform signal processing to manipulate signals or states or to construct signals or states, for example.

Memory 470 may be representative of any storage mechanism. Memory 470 may comprise, for example, primary memory 474 and secondary memory 476, additional memory circuits, mechanisms, or combinations thereof may be used. Memory 470 may comprise, for example, random access memory, or one or more data storage devices or systems, such as, for example, a disk drive, an optical disc drive, a tape drive, a solid-state memory drive, or other writable memory, just to name a few examples. Memory 470 may be utilized to store a program, as an example. Memory 470 may also comprise a memory controller for accessing computer readable-medium 480 that may carry and/or make accessible content, code, and/or instructions, for example, executable by processor 450 or some other controller or processor capable of executing instructions, for example. In appropriate situations, memory 470 may also comprise a computer-readable medium that may carry and/or make accessible content, code and/or instructions, for example, executable by processor 450 or some other controller or processor capable of executing instructions, for example.

Under the direction of processor 450, memory, such as cells storing physical states, representing for example, a program, may be executed by processor 450 and generated signals may be transmitted via the Internet, for example. Processor 450 may also receive digitally-encoded signals from server 400.

Network 415 may comprise one or more communication links, processes, and/or resources to support exchanging communication signals between a client and server, which may, for example, comprise one or more servers (not shown). By way of example, but not limitation, network 415 may comprise wireless and/or wired communication links, telephone or telecommunications systems, Wi-Fi networks, Wi-MAX networks, the Internet, the web, a local area network (LAN), a wide area network (WAN), or any combination thereof.

The term “computing platform,” as used herein, refers to a system and/or a device, such as a computing device, that includes a capability to process and/or store data in the form of signals and/or states. Thus, a computing platform, in this context, may comprise hardware, software, firmware, or any combination thereof (other than software per se). Computing platform 410, as depicted in FIG. 4, is merely one such example, and the scope of claimed subject matter is not limited to this particular example. For one or more embodiments, a computing platform may comprise any of a wide range of digital electronic devices, including, but not limited to, personal desktop or notebook computers, high-definition televisions, digital versatile disc (DVD) players and/or recorders, game consoles, satellite television receivers, cellular telephones, personal digital assistants, mobile audio and/or video playback and/or recording devices, or any combination of the above. Further, unless specifically stated otherwise, a process as described herein, with reference to flow diagrams and/or otherwise, may also be executed and/or affected, in whole or in part, by a computing platform.

Regarding aspects related to a communications or computing network, a wireless network may couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, and/or the like, which may move freely, randomly or organize themselves arbitrarily, such that network topology may change, at times even rapidly. Wireless network may further employ a plurality of network access technologies, including Long Term Evolution (LTE), WLAN, Wireless Router (WR) mesh, or 2nd, 3rd, or 4th generation (2G, 3G, or 4G) cellular technology, or other technologies, or the like. Network access technologies may enable wide area coverage for devices, such as client devices with varying degrees of mobility, for example.

A network may enable radio frequency or wireless type communications via a network access technology, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or other, or the like. A wireless network may include virtually any type of now known, or to be developed, wireless communication mechanism by which signals may be communicated between devices, such as a client device or a computing device, between or within a network, or the like.

Communications between a computing device and a wireless network may be in accordance with known, or to be developed cellular telephone communication network protocols including, for example, global system for mobile communications (GSM), enhanced data rate for GSM evolution (EDGE), and worldwide interoperability for microwave access (WiMAX). A computing device may also have a subscriber identity module (SIM) card, which, for example, may comprise a detachable smart card that stores subscription information of a user, and may also store a contact list of the user. A user may own the computing device or may otherwise be its primary user, for example. A computing device may be assigned an address by a wireless or wired telephony network operator, or an Internet Service Provider (ISP). For example, an address may comprise a domestic or international telephone number, an Internet Protocol (IP) address, and/or one or more other identifiers. In other embodiments, a communication network may be embodied as a wired network, wireless network, or combination thereof.

A computing device may vary in terms of capabilities or features. Claimed subject matter is intended to cover a wide range of potential variations. For example, a network device may include a numeric keypad or other display of limited functionality, such as a monochrome liquid crystal display (LCD) for displaying text. In contrast, however, as another example, a web-enabled computing device may include a physical or a virtual keyboard, mass storage, one or more accelerometers, one or more gyroscopes, global positioning system (GPS) or other location-identifying type capability, and/or a display with a higher degree of functionality, such as a touch-sensitive color 2D or 3D display, for example.

A computing device may include or may execute a variety of now known, or to be developed operating systems, or derivatives and/or versions, including personal computer operating systems, such as a Windows, iOS or Linux, or a mobile operating system, such as iOS, Android, or Windows Mobile, or the like. A computing device may include or may execute a variety of possible applications, such as a client software application enabling communication with other devices, such as communicating one or more messages, such as via email, short message service (SMS), or multimedia message service (MMS), including via a network, such as a social network including, but not limited to, Facebook, LinkedIn, Twitter, Flickr, or Google+, to provide only a few examples. A computing device may also include or execute a software application to communicate content, such as, for example, textual content, multimedia content, or the like. A computing device may also include or execute a software application to perform a variety of possible tasks, such as browsing, searching, playing various forms of content, including locally stored or streamed video, or games such as, but not limited to, fantasy sports leagues. The foregoing is provided merely to illustrate that claimed subject matter is intended to include a wide range of possible features or capabilities.

A network including a computing device, for example, may also be extended to another device communicating as part of another network, such as via a virtual private network (VPN). To support a VPN, transmissions may be forwarded to the VPN device. For example, a software tunnel may be created. Tunneled traffic may, or may not be encrypted, and a tunneling protocol may be substantially complaint with or substantially compatible with any past, present or future versions of any of the following protocols: IPSec, Transport Layer Security, Datagram Transport Layer Security, Microsoft Point-to-Point Encryption, Microsoft's Secure Socket Tunneling Protocol, Multipath Virtual Private Network, Secure Shell VPN, or another existing protocol, or another protocol that may be developed.

A network may be compatible with now known, or to be developed, past, present, or future versions of any, but not limited to the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, or X.25. A network may employ, for example, TCP/IP, UDP, DECnet, NetBEUI, IPX, Appletalk, other, or the like. Versions of the Internet Protocol (IP) may include IPv4, IPv6, other, and/or the like.

It will, of course, be understood that, although particular embodiments will be described, claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example (other than software per se). Likewise, although claimed subject matter is not limited in scope in this respect, one embodiment may comprise one or more articles, such as a storage medium or storage media. Storage media, such as, one or more CD-ROMs and/or disks, for example, may have stored thereon instructions, executable by a system, such as a computer system, computing platform, or other system, for example, that may result in an embodiment of a method in accordance with claimed subject matter being executed, such as a previously described embodiment, for example; although, of course, claimed subject matter is not limited to previously described embodiments. As one potential example, a computing platform may include one or more processing units or processors, one or more devices capable of inputting/outputting, such as a display, a keyboard and/or a mouse, and/or one or more memories, such as static random access memory, dynamic random access memory, flash memory, and/or a hard drive.

In the preceding detailed description, numerous specific details have been set forth to provide a thorough understanding of claimed subject matter. However, it will be understood by those skilled in the art that claimed subject matter may be practiced without these specific details. In other instances, methods and/or apparatuses that would be known by one of ordinary skill have not been described in detail so as not to obscure claimed subject matter. Some portions of the preceding detailed description have been presented in terms of logic, algorithms and/or symbolic representations of operations on binary signals or states, such as stored within a memory of a specific apparatus or special purpose computing device or platform. In the context of this particular specification, the term specific apparatus or the like includes a general purpose computing device, such as general purpose computer, once it is programmed to perform particular functions pursuant to instructions from program software.

Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involves physical manipulation of physical quantities. Typically, although not necessarily, such quantities may take the form of electrical and/or magnetic signals and/or states capable of being stored, transferred, combined, compared, processed or otherwise manipulated as electronic signals and/or states representing information. It has proven convenient at times, principally for reasons of common usage, to refer to such signals and/or states as bits, data, values, elements, symbols, characters, terms, numbers, numerals, information, and/or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing device. In the context of this specification, therefore, a special purpose computer and/or a similar special purpose computing device is capable of processing, manipulating and/or transforming signals and/or states, typically represented as physical electronic and/or magnetic quantities within memories, registers, and/or other information storage devices, transmission devices, and/or display devices of the special purpose computer and/or similar special purpose computing device. In the context of this particular patent application, as mentioned, the term “specific apparatus” may include a general purpose computing device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation and/or a physical change or transformation in molecular structure, such as from crystalline to amorphous or vice-versa. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

While there has been illustrated and/or described what are presently considered to be example features, it will be understood by those skilled in the relevant art that various other modifications may be made and/or equivalents may be substituted, without departing from claimed subject matter. Additionally, many modifications may be made to adapt a particular situation to the teachings of claimed subject matter without departing from one or more central concept(s) described herein. Therefore, it is intended that claimed subject matter not be limited to the particular examples disclosed, but that such claimed subject matter may also include all aspects falling within appended claims and/or equivalents thereof.

1. An apparatus comprising: a channel providing a communication path for display signals including a device along the communication path, the device including a buffer for the display signals smaller than a frame.

2. The apparatus of claim 1, wherein the device along the path also includes the capability to at least partially manage bandwidth to a display via the communication path.

3. The apparatus of claim 2, wherein the capability to at least partially manage bandwidth to a display via the communication path comprises the capability to at least partially dynamically manage transmission of display signals to a display via the communication path.

4. The apparatus of claim 3, wherein the capability to at least partially dynamically manage transmission of display signals to a display via the communication path comprises the capability to at least partially dynamically manage transmission of display signals via one or more heuristics using a plurality of display signal processing techniques so that display signals continue to be transmitted with a graceful reduction of display signal content even if channel capacity reduces.

5. The apparatus of claim 3, wherein the capability to at least partially dynamically manage transmission of display signals to a display via the communication path comprises the capability to at least partially dynamically manage transmission of display signals via one or more heuristics using a plurality of display signal processing techniques so that display signals continue to be transmitted with a graceful reduction of display output signal content even as channel capacity reduces.

6. The apparatus of claim 3, wherein the capability to at least partially dynamically manage transmission of display signals to a display via the communication path comprises the capability to at least partially dynamically manage transmission of display signals via one or more heuristics using a plurality of display signal processing techniques so that display signals continue to be transmitted even if channel capacity reduces.

7. The apparatus of claim 3, wherein the capability to at least partially dynamically manage transmission of display signals to a display via the communication path comprises the capability to at least partially dynamically manage transmission of display signals via one or more heuristics using a plurality of display signal processing techniques so that display signals continue to be transmitted even as channel capacity reduces.

8. The apparatus of claim 6, wherein the capability to at least partially dynamically manage transmission of display signals via one or more heuristics using a plurality of display signal processing techniques so that display signals continue to be transmitted even if channel capacity reduces comprises using at least one of the following: reducing display signal frame rate; employing display signal color compression; reducing display signal color depth; reducing display signal resolution, employing clipping of display signals or any combination thereof.

9. The apparatus of claim 3, wherein the capability to at least partially dynamically manage transmission of display output signals to a display via the communication path comprises the capability to at least partially dynamically manage isochronous display signal transmission.

10. The apparatus of claim 9, wherein the capability to at least partially dynamically manage isochronous display signal transmission comprises the capability to transmit display signals in a manner to at least partially account for display raster beam timing.

11. The apparatus of claim 10, wherein the capability to transmit display signals comprises a capability to transmit at least one of the following: frames, packets, or microframes.

12. The apparatus of claim 10, wherein the capability to at least partially dynamically manage isochronous display signal transmission comprises the capability to at least partially dynamically manage isochronous display rate synchronization.

13. The apparatus of claim 12, wherein the capability to dynamically manage isochronous display rate synchronization comprises the capability to at least partially dynamically manage isochronous display rate synchronization via ITP skewing.

14. The apparatus of claim 12, wherein the capability to dynamically manage isochronous display rate synchronization comprises the capability to at least partially dynamically manage isochronous display rate synchronization via microframe transmission rate adjustment.

15. The apparatus of claim 1, wherein the channel comprises at least one of the following: a serial channel; a parallel channel; a wireless channel; a single lane channel; a multiple lane channel; or any combinations thereof.

16. The apparatus of claim 1, wherein the apparatus is part of at least one of the following systems: a computer system; a television system; a set top box system; or any combinations thereof.

17. An article comprising: a storage medium having stored thereon instructions executable to at least partially manage bandwidth to a display via a communication path comprising a channel of a device, the device including a buffer for the display signals smaller than a frame.

18. The article of claim 17, wherein the instructions being further executable to at least partially manage bandwidth to a display via the communication path comprises the instructions being executable to at least partially dynamically manage transmission of display signals to a display via the communication path.

19. The article of claim 18, wherein the instructions being further executable to at least partially dynamically manage transmission of display signals to a display via the communication path comprises the instructions being further executable to at least partially dynamically manage transmission of display signals via one or more heuristics using a plurality of display signal processing techniques so that display signals continue to be transmitted with a graceful reduction of display signal content even if channel capacity reduces.

20. The article of claim 18, wherein the instructions being further executable to at least partially dynamically manage transmission of display signals to a display via the communication path comprises the instructions being further executable to at least partially dynamically manage transmission of display signals via one or more heuristics using a plurality of display signal processing techniques so that display signals continue to be transmitted with a graceful reduction of display output signal content even as channel capacity reduces.

21. The article of claim 18, wherein the instructions being further executable to at least partially dynamically manage transmission of display signals to a display via the communication path comprises the instructions being further executable to at least partially dynamically manage transmission of display signals via one or more heuristics using a plurality of display signal processing techniques so that display signals continue to be transmitted even if channel capacity reduces.

22. The article of claim 18, wherein the instructions being further executable to at least partially dynamically manage transmission of display signals to a display via the communication path comprises the instructions being further executable to at least partially dynamically manage transmission of display signals via one or more heuristics using a plurality of display signal processing techniques so that display signals continue to be transmitted even as channel capacity reduces.

23. The article of claim 22, wherein the instructions being further executable to at least partially dynamically manage transmission of display signals via one or more heuristics using a plurality of display signal processing techniques so that display signals continue to be transmitted even if channel capacity reduces comprises using at least one of the following: reducing display signal frame rate; employing display signal color compression; reducing display signal color depth; reducing display signal resolution, employing clipping of display signals or any combination thereof.

24. The article of claim 18, wherein the instructions being further executable to at least partially dynamically manage transmission of display output signals to a display via the communication path comprises the instructions being further executable to at least partially dynamically manage isochronous display signal transmission.

25. The article of claim 24, wherein the instructions being further executable to at least partially dynamically manage isochronous display signal transmission comprises the instructions being further executable to transmit display signals in a manner to at least partially account for display raster beam timing.

26. The article of claim 25, wherein the instructions being further executable to at least partially dynamically manage isochronous display signal transmission comprises the instructions being further executable to transmit display signals in a manner to at least partially account for display raster beam timing; wherein the display signals comprise at least one of the following: packets, frames, or microframes.

27. The article of claim 25, wherein the instructions being further executable to at least partially dynamically manage isochronous display signal transmission comprises the instructions being further executable to at least partially dynamically manage isochronous display rate synchronization.

28. The article of claim 27, wherein the instructions being further executable to dynamically manage isochronous display rate synchronization comprises the instructions being further executable to at least partially dynamically manage isochronous display rate synchronization via ITP skewing.

29. The article of claim 27, wherein the instructions being further executable to dynamically manage isochronous display rate synchronization comprises the instructions being further executable to at least partially dynamically manage isochronous display rate synchronization via microframe transmission rate adjustment.

30. The article of claim 17, the instructions being executable to at least partially manage throughput to a display via a communication path comprising a channel of a device, wherein the channel comprises at least one of the following: a serial channel; a parallel channel; a wireless channel; a single lane channel; a multiple lane channel; or any combinations thereof.

31. The article of claim 17, wherein the instructions executable to at least partially manage throughput to a display via a communication path comprising a channel of a device, wherein the device comprises part of at least one of the following systems: a computer system; a television system; a set top box system; or any combinations thereof.

32. A method comprising: at least partially managing throughput to a display via a communication path comprising a channel of a device, the device including a buffer for the display signals smaller than a frame.

33. The method of claim 32, wherein the least partially managing throughput to a display via the communication path comprises at least partially dynamically managing transmission of display signals to a display via the communication path.

34. The method of claim 33, wherein the least partially dynamically managing transmission of display signals to a display via the communication path comprises at least partially dynamically managing transmission of display signals via one or more heuristics using a plurality of display signal processing techniques so that display signals continue to be transmitted with a graceful reduction of display signal content even if channel capacity reduces.

35. The method of claim 33, wherein the at least partially dynamically managing transmission of display signals to a display via the communication path comprises at least partially dynamically managing transmission of display signals via one or more heuristics using a plurality of display signal processing techniques so that display signals continue to be transmitted with a graceful reduction of display output signal content even as channel capacity reduces.

36. The method of claim 33, wherein the at least partially dynamically managing transmission of display signals to a display via the communication path comprises at least partially dynamically manage transmission of display signals via one or more heuristics using a plurality of display signal processing techniques so that display signals continue to be transmitted even if channel capacity reduces.

37. The method of claim 33, wherein the least partially dynamically managing transmission of display signals to a display via the communication path comprises at least partially dynamically managing transmission of display signals via one or more heuristics using a plurality of display signal processing techniques so that display signals continue to be transmitted even as channel capacity reduces.

38. The method of claim 37, wherein the at least partially dynamically managing transmission of display signals comprises via one or more heuristics using a plurality of display signal processing techniques so that display signals continue to be transmitted even if channel capacity reduces comprises using at least one of the following: reducing display signal frame rate; employing display signal color compression; reducing display signal color depth; reducing display signal resolution, employing clipping of display signals or any combination thereof.

39. The method of claim 33, wherein the least partially dynamically managing transmission of display output signals to a display via the communication path comprises at least partially dynamically managing isochronous display signal transmission.

40. The method of claim 39, wherein the least partially dynamically managing isochronous display signal transmission comprises transmitting of display signals in a manner to at least partially account for display raster beam timing.

41. The method of claim 40, wherein transmitting of display signals comprises transmitting at least one of the following: frames, packets, or microframes.

42. The method of claim 40, wherein the at least partially dynamically managing isochronous display signal transmission comprises at least partially dynamically managing isochronous display rate synchronization.

43. The method of claim 42, wherein the at least partially dynamically managing isochronous display rate synchronization comprises at least partially dynamically managing isochronous display rate synchronization via ITP skewing.

44. The method of claim 42, wherein the at least partially dynamically managing isochronous display rate synchronization comprises at least partially dynamically managing isochronous display rate synchronization via microframe transmission rate adjustment.

45. The method of claim 32, wherein the least partially managing throughput to a display via a communication path comprises a channel of a device, wherein the channel comprises at least one of the following: a serial channel; a parallel channel; a wireless channel; a single lane channel; a multiple lane channel; or any combinations thereof.

46. The article of claim 32, wherein the at least partially manage throughput to a display via a communication path comprises a channel of a device, wherein the device comprises part of at least one of the following systems: a computer system; a television system; a set top box system; or any combinations thereof.
